(19) United States
(12) Patent Application Publication
(10) Pub. No.: US 2011/0226056 A1
(43) Pub. Date: Sep. 22, 2011

(54) METHOD FOR SIMULATING THE OPERATING BEHAVIOR OF A CORIOLIS GYRO

(76) Inventor: Werner Schroeder, Offenburg (DE)

(21) Appl. No.: 12/998,646

(22) PCT Filed: Nov. 12, 2009
(86) PCT No.: PCT/EP2009/008066

§ 371 Date: May 12, 2011

(30) Foreign Application Priority Data
Nov. 14, 2008 (DE) 10 2008 057 281.0

(51) Int. Cl. G01C 19/56

(52) U.S. Cl. 73/504.12

(57) ABSTRACT

A method for characterizing Coriolis gyros, in the case of which the interaction of the system comprising force transmitters, a mechanical resonator and excitation/readout vibration pick-offs is represented as a discretized, coupled system of differential equations. The variables of the system of equations represent the force signals supplied by the force transmitters to the mechanical resonator and the readout signals produced by the excitation/readout vibration pick-offs. The coefficients of the system of equations contain information relating to the linear transformation which maps the force signals onto the readout signals. The coefficients are determined by measuring force signal values and readout signal values at different instants and substituting them into the system of equations. The system of equations is numerically resolved in accordance with the coefficients, and the coefficients are used to infer undesired bias properties of the Coriolis gyro which corrupt the rate of rotation of the Coriolis gyro.

### BACKGROUND

1. Field of the Invention

The present invention relates to Coriolis gyroscopes. More specifically, the invention pertains to a method for simulation of the operating behavior of a Coriolis Gyro.

2. Description of the Prior Art

Coriolis gyros (also termed vibration gyros), in which a mass system is set vibrating, are increasingly used for navigation. Vibrations of the mass system (also denoted a resonator) are, as a rule, a superposition of a multiplicity of individual vibrations that are independent of one another. To operate a Coriolis gyro, the resonator is first artificially set to one of the individual vibrations (“excitation vibration”). When the Coriolis gyro is moved or rotated, Coriolis forces occur that extract energy from the excitation vibration of the resonator and excite a further individual vibration of the resonator (“readout vibration”). The excitation and readout vibrations are thus independent of one another in the Coriolis gyro state of rest and are coupled to one another only during rotation. Consequently, rotations of the Coriolis gyro can be determined by picking off the readout vibration and evaluating a corresponding readout vibration pick-off signal. Changes in amplitude of the readout vibration constitute a measure of rotation of the Coriolis gyro. Coriolis gyros are preferably implemented as closed loop systems in which respective control loops are used to continuously reset the amplitude of the readout vibration to a fixed value (preferably zero).

Any desired number of individual vibrations of the resonator can be excited in principle. One of the individual vibrations is the artificially produced excitation vibration. Another individual vibration constitutes the readout vibration excited by Coriolis forces during rotation of the gyro. Due to mechanical structure or unavoidable manufacturing tolerances, it is impossible to prevent other individual vibrations of the resonator, some far from resonance, from being excited in addition to the excitation and readout vibrations. The undesirably excited individual vibrations change the readout vibration pick-off signal, as they are also read out, at least in part, at the readout vibration signal pick-off.

Due to the manufacturing tolerances mentioned above, it is also necessary to accept slight misalignments between the excitation resetting forces/force transmitters/pick-offs and the natural vibrations of the resonator (i.e., the real excitation and readout modes of the resonator). This also gives rise to “corruption” of the readout vibration pick-off signal.

The readout vibration pick-off signal is thus composed of a part responsive to Coriolis forces, a part due to excitation of undesirable resonances, and a part that results from misalignments between the excitation resetting forces/force transmitters/pick-offs and the natural vibrations of the resonator. The undesirable portions cause bias terms whose magnitudes are unknown, the result being corresponding errors in the evaluation of the readout vibration pick-off signal.

Similar considerations apply to the excitation vibration pick-off signal.

### SUMMARY AND OBJECTS OF THE INVENTION

It is therefore an object of the invention to provide a method for estimating the influence and/or magnitude of bias terms in the output of a Coriolis gyro.

Such object and others are achieved by the present invention which provides a method for simulating the operating behavior of a Coriolis gyro. According to such method, the interaction of the system comprising force transmitters, a mechanical resonator and excitation/readout vibration pick-offs is represented as a discretized, coupled system of differential equations.

The variables of the system of equations represent the force signals supplied to the mechanical resonator by the force transmitters, and the readout signals produced by the excitation/readout vibration pick-offs. The coefficients of the system of equations contain information relating to the linear transformation that maps the force signals onto the readout signals.

The coefficients are determined by measuring force signal values and readout signal values at different instants and substituting them into the system of equations, and the system of equations is resolved numerically in accordance with the coefficients. The coefficients are used to infer undesired bias properties of the Coriolis gyro which corrupt the rate of rotation of the Coriolis gyro.

The foregoing and other features of the invention will become further apparent from the detailed description that follows. In such description, the term “readout signal” covers the excitation/readout vibration pick-off signals and all other signals derived from these signals and include information relating to the excitation/readout vibration. A readout signal representing the readout vibration is also denoted as a readout vibration signal, while a readout signal representing the excitation vibration is also denoted as an excitation vibration signal.

### DETAILED DESCRIPTION OF THE PREFERRED EMBODIMENT

A Coriolis sensor utilizes two vibrations that are coupled through the Coriolis effect. They are excited by force transmitters and read out by pick-off sensors. In addition, further vibrations, whose frequency should be as far removed as possible from the first two vibrations, are somewhat excited and also read out as interfering vibrations. Moreover, in an actual gyro, the excitations are crosswise coupled to a slight extent, and are therefore also read out in crosswise coupled fashion.

It is the aim of the invention to separate the error terms from the rate of rotation of interest in a way that is substantially free from error. To this end, white, preferably digital noise of limited bandwidth that may not be correlated for the two force transmitters is supplied to the two force transmitters F1 and F2. Pick-off sensors A1 and A2 are sampled. Autocorrelation functions KF1F1, KF2F2, KA1A1 and KA2A2 and cross correlations KF1A1, KF2A2, KA1A2 as well as KF1A2 and KF2A1, are then continuously calculated. Such calculation is performed in two sets so that one set of correlations is calculated using a time constant that substantially corresponds to the gyro bandwidth and another is calculated with a substantially larger time constant. This can be performed so that the slow set reverts to the values of the fast one, and is subjected to low-pass filtering of a few minutes with “memory”. The correlations can be calculated recursively (i.e., in the manner of a single channel Kalman filter). The correlations can also be calculated by known Fourier transformations if the length of the data vectors is much longer than the time constant of the two substantial vibrations in the sensor. The correlations need be calculated only for a small maximum number of displacements (e.g. 100).

The slow set of correlations serves to calculate the properties of the Coriolis sensor (e.g. resonant frequencies, attenuations and cross couplings). This information is used to carry out fast calculation of the rate of rotation of the gyro and, if appropriate, further values, such as a frequency to be electronically tuned, doing so with low noise in step with the gyro bandwidth with the aid of a greatly reduced matrix.

The method is based on the following fundamental principle. For example, in digital form, the output of a channel is:

y(n)=a1·y(n−1)+a2·y(n−2)+b1·u(n−1)+b2·u(n−2),

u(n) being the input values. The following is yielded by the correlation and averaging with the aid of the input signal u(n):

Kuy(τ)=a1·Kuy(τ−1)+a2·Kuy(τ−2)+b1·Kuu(τ−1)+b2·Kuu(τ−2).

Kuy(τ) is the cross correlation, Kuu(τ) being the auto-correlation of the input signal.

A set of equations for various τ can be solved recursively, or nonrecursively, with a minimum error in the L2 norm for the IIR coefficients a1, a2 and the FIR coefficients b1, b2.

There is a range of recursive methods of solution as well as MKQ etc., and the direct solution.

For the direct one, a vector is formed from the cross correlations. A matrix is formed from the auto and cross correlations.

Vector: Φuy Matrix: S.

The parameter vector z of the coefficients a1, a2, b1, b2 is calculated as follows:

z=(S^{T}·S)⁻¹·S^{T}·Φuy.

This method for parameter identification is free from bias (as many others are not) and stable (which is not necessarily so for recursive methods, in particular), and comparatively quick.

An important aspect of the invention may be described as follows: the normalized cross correlations yield simply the filter coefficients (pulse response) of the (infinitely long) FIR filter which is equivalent to the IIR filter and has the length of the cross-correlation vector. The algorithm of the differential equation is back calculated from the filter coefficients. The method functions correctly even given additional noise in the pick-offs that is average free.

The differential equations of the two vibrations and, if appropriate, third vibrations, are set up with their couplings for the Coriolis sensor. These equations are transformed into the s-domain and decomposed into partial fractions. They are then transformed into the z-domain, there being a need to take account of the sample-hold element at the force input. The system of differential equations for the gyro can be produced therefrom. Moreover, the relationship is yielded between the physical sizes of the gyro and the coefficients of the differential equation. Because of the generally high Q factor of the vibrations, this pulse invariant method seems best suited for producing the differential equations. Other methods exist (e.g. direct integration).

The output signals from a pick-off sensor are then derived as a sum, weighted with the coefficients, of the dedicated, old output values (recursive component) and the input forces, in general, of both channels due to couplings and the rate of rotation (nonrecursive component).

Employing knowledge of the differential equations, S-matrices and Φ-vectors are then formed from the slow correlations, and the coefficients are estimated as specified above. If appropriate, the physical variables of interest are calculated therefrom.

Virtually all parameters change only very slowly, and some are already present in a plurality of transfer functions. In order to separate calculation of the rapidly variable parameters from those that are relatively substantially constant, the above calculation is carried out employing the correlations with a longer time constant. The slowly variable parameters are very well known and can be partially averaged out of a plurality of functions. The parameter vectors are then split into a vector with known parameters, “zb”, and one with the few parameters to be estimated in a brief time, “zu”. The correlation matrices Sb and Su are formed accordingly. It then holds that:

Φb=Φuy−Sb^{T}·zb,

and thus (the rate of rotation being present in zu):

zu=(Su^{T}·Su)⁻¹·Sa^{T}·νΦb.

This calculation must be carried out, in accordance with gyro bandwidth, only every 1 to 10 ms. The calculation of all the parameters must be carried out only every few seconds. The calculations are nonrecursive, and, therefore, run at a constant rate and without convergence problems. The numerical inversions can, for example, be carried out directly (given very small matrices) or by means of the Householder algorithm. The matrices to be inverted are only of magnitude: length_parameter vector*length_parameter vector; the inversions therefore barely required computation time. With other known parameters, “zu” is naturally substantially less noisy than over common calculation of the parameters. It is also possible to assume that some parameters are fixed from the very start to improve accuracy. When both vibrations move, the above product matrix can, moreover, always be inverted (determinants near zero could be used for BITE purposes).

Since the rate of rotation experiences a speed coupling between the two vibrators, it is also possible to establish therefrom a coupling relationship of one output to the other in which the rate of rotation is present. The differential equation for ×2 at output A2 (pick-off of the readout vibration) has, for example, the following approximate form:

x2(n)=a1·x2(n−1)+a2·x2(n−1)+b1·F2(n−1)+b2·F2(n−2)+c1·x1(n−1)+c2·x1(n−2).

Multiplication by x1(n+τ) and time averaging yield:

KA1A2(τ)=a1·Ka1A2(τ−1)+a2·KA1A2(τ−1)+b1·KF2A1(τ−1) . . . +b2·KF2A1(τ=2)+c1·KA1A1(τ−1)+c2·KA1A1(τ−2)

Parameters a1, a2, b1 and b2 are already estimated in the slow parameter estimation. The correlation functions are all already measured. The calculation of c1, c2, directly proportional to the rate of rotation, can be carried out separately as described above. The idea in such case is that the rate of change of one output multiplied by the rate of rotation is the force that excites the other output uncorrelated with the excitation of the other output. If the transfer function of this channel is known (e.g., by parameter estimation), the rate of rotation can be back calculated from the cross-correlation function.

The method also functions, in principle, with colored noise. In such case, the number of values to be correlated and the size of the S-matrix would grow with decreasing bandwidth of the noise signal as more values of the correlation functions should be known. With reference to the excitation of third modes, it is even advantageous to limit the bandwidth of the excitation noise so that the third modes are not excited. Bandwidth limited noise can be produced by passing a digital random signal through a digital bandpass filter.

Pseudo-random bit signals (feedback shift register) for excitation possess the advantage that the autocorrelation functions need not be calculated when the computing cycle times are tuned to the repetition times of the signals. However, there are problems in systems with a long memory (e.g. MEMS).

A glance at the pole positions of the Z-transforms H(z) of a 10 kHz MEMS gyro shows that extraction of the operating frequency from the parameters requires calculation of a nonlinear function. This can be calculated more accurately in the steep branch of the function. That is, a sampling period of 10 to 20 μs will be more accurate in this regard than a shorter one. Moreover, a lower bit rate of the excitation yields more movement in the sensor. A long sampling period is particularly advantageous with regard to real time applications.

The electronics of such a gyro would be substantially reduced to a DAC for frequency tuning (to the extent required), an ADC with multiplexer for the pick-offs and an advanced performance “number cruncher”.

The advantages of the above method are evident to the extent that it has an adequately low noise level and runs accurately. The basic principle has been tested and examined by control engineering. The method was simulated on a second order system and good results were obtained in a short measuring time. It is advantageous that first estimates of the physical parameters are already on hand after a short simulation time and become more and more accurate with increasing measuring time.

Implementation in a DSP (computing time estimates for SHARC 90 mHz) could be as follows. Let the sample period be 20 μs. With this clock pulse, the force transmitters are excited digitally with signals of two different and uncorrelated digital random number generators, and the pick-offs are read out. The signals are stored in long ring memories. A maximum nine correlations are calculated for a limited number of displacement lengths. Approximately 80 correlations can be calculated and summed in 1 μs. As a consequence, approximately 400 correlations can be calculated in 5 μs (approximately 45 displacements for each signal; the optimum division can be determined by simulation).

These correlations are averaged in the gyro clock pulse (approximately 1 ms to 10 ms) in a recursive low pass filter with a “memory” of a plurality of minutes, and yield the set of slow correlations. The fast correlations are restarted at zero in the gyro clock pulse. This method would produce “aliasing” of the rate of rotation, but it would be better to calculate the fast correlations by using a filter with a short “memory”.

As described above, the complete set of coefficients is calculated at time intervals of approximately 1 s from the slow correlations. The rate of rotation and, for example, a resonant frequency (which can then be used to perform electronic tuning) are calculated as described above in the gyro clock pulse from the quick correlations together with the information of the now known parameters.

The calculation of “zu” required in real time and with a clock pulse of approximately 1 ms is very fast (substantially, 2 to 4 matrix multiplications with 2*50 matrices a approximately 2.5 μs and direct matrix inversion of 2*2 matrices). The slow parameter calculations can be interpolated. It should be possible to implement real time operation given a 20 μs sampling time. All routines (filtered correlation and matrix multiplication) are DSP typical and can be effectively programmed in an assembler, while the matrix inversion program (not time critical) for larger matrices should probably be programmed in C. The back calculation of physical variables from the parameters partly requires the extraction of roots and trigonometric functions (tables, approximation formulas or Codec methods).

Parameter estimation methods as above are optimum for characterizing error terms; in particular, because it automatically identifies, per cross correlation, even coefficients of the real sensor possibly overlooked in the system model, so to say a two step method: system identification and parameter estimation in one.

FFTs (Fast Fourier Transformation) for the slow correlation are appropriate only when the DSP has a very large internal memory and the gyro Q factor is not excessively high. FFTs substantially accelerate calculation of long correlation vectors and are, therefore, to be preferred as appropriate for offline parameter estimation using a PC.

The IIR coefficients of the direct transfer functions, of 2nd order, yield the attenuations and resonance frequencies. The cross transfer functions are of 4th order, and of interest only for the nonrecursive part that contains the cross couplings and rate of rotation. The rate of rotation component is already obtained solely from the cross correlation of the output signals given knowledge of the slowly variable parameters.

In practical implementation, a problem can arise in that the excitation is overcoupled electrically into the readout, resulting in corruption of the calculation of the mechanical cross coupling terms. This problem can be met by selecting the instants of excitation and readout with a time offset (e.g., by 10 μs). Of course, such time shift is to be taken into account in setting up the z-transform for the gyro system. Moreover, the readout channel requires an appropriately high bandwidth, and there may be a need for multiple sampling in a clock period due to aliasing.

In the case of a MEMS gyro, the coefficients determined by slow parameter estimation can be stored in a non-volatile, overwritable memory, for example via temperature. The gyro software can fetch starting values from this memory after switch on. The random digital excitation should not cause any problem through excitation of high natural mechanical resonances. It will be advantageous not to place the clock frequency precisely at a system natural resonance of higher order. Otherwise, the transfer function is easily obtained regarding amplitude and phase response by FFT from the cross correlations.

The method described is therefore suitable in principle for reading out a gyro and for testing and calibration. The most accessible information is obtained via the mechanical Coriolis gyro system and its error terms in optimum time. Moreover, in a few designs (such as, for example, Lin or Lin-Lin), acceleration of the “readout vibration” can be quickly estimated, and thus an acceleration output can additionally be provided.

An essential aspect of the invention can therefore be described as follows: if white noise is supplied to a system, the normalized cross correlation of input and output signals yields the pulse response of the system. This is equal to the filter coefficients in the case of digital systems. For recursive films—as here—the result is an infinitely long sequence of filter coefficients that consist of a sum of exponentially decreasing complex values (whose sum is naturally real because of complexly conjugate poles in the Z-plane). A first section is taken from this sequence to calculate the filter coefficients. The method is true to expectations. That is, it tends to the exact value for long averaging times of the correlation functions.

The attained accuracy of coefficient averaging can be determined from the absolute value of the difference vector between cross-correlation vector and multiplication of the correlation matrix by the parameter vector. This information can be used to indicate that calculated parameters are to be seen as “valid”.

This method requires very simple electronics consisting of a DAC—if electronic tuning to double resonance is desired—an ADC with a multiplexer, and one or two (or FPGA/ASIC) DSP with, for example, the efficiency of an analog device SHARC.

In the case of a MEMS gyro with a 10,000 kHz resonance frequency, a vibration Q factor of 10,000 and a sampling rate of 20 μs, excitation requires an excitation amplitude of roughly ±300 m/s² for the digital stochastic force excitations in the MEMS, in order to attain a maximum random vibration amplitude of approximately 5 μm.

The method will estimate the bias in a manner substantially independent of the Q factor of the gyro. This becomes evident from the closed solution of the system equations in which only four terms occur in the case of resetting of the readout vibration and double resonance: cross coupling input forces, cross coupling readout and third modes/electrical coupling (in each case with the Q factor in the denominator) and the cross attenuation. In this method, the cross couplings are estimated and separated, whereas the cross attenuation is not. It may be presumed that the cross attenuation term drops out for symmetrical structures and the equal amplitude. The influence of third resonances can be reduced in any case by bandwidth limited noise.

Presumably, the double resonance with a high Q factor will yield a substantial noise advantage.

The advantages of the invention include estimation of the rate of rotation independent of cross coupling errors, and comparatively simple electronics. All that remains necessary is a control loop for the electronic tuning or, for example, for mean deflection in the case of Lin-Lin—if desired (in the case of Lin-Lin, the mean deflection may also be estimated, with the result that there is also an acceleration output).

The demands placed on the gyro structure and analog electronics for this method are as follows:
two structural resonances with adequate Q factor that are coupled by the rate of rotation and
their resonance frequencies are tuned to one another or are already so (for example, electronically and by laser trim):
the cross attenuation of the two vibrations must be as small as possible;
the resonant frequencies of further structural resonances must be far removed and excited as little as possible;
the two dominant modes must couple mechanically to the surroundings as little as possible;
vibrations from outside are to couple as little as possible into the dominant modes;
pick-offs must operate linearly;
the pick-off noise must be sufficiently low;
the pick-off electronics must have a bandwidth of approximately 200 kHz;
the pick-off electronics must have a well defined amplitude and phase response over a wide frequency range that must, if appropriate, be digitally compensated.

The following points are insignificant to a first approximation:
force excitation characteristic linear or quadratic;
force cross coupling;
readout cross coupling; and
electromagnetic crosstalk.

Alternatively, the coefficients of a linear differential equation (here: second or fourth order) on which a system is based can also be determined in the following way directly without a detour via z-transformation.

Autocorrelation (AKF) and cross-correlation functions (KKF) have been sampled and calculated as described. Their derivatives are then formed. To this end, the AKF and the KKF values are to be combined, for example by means of spline functions (of which there is a fast algorithm), and differentiated numerically at the sample times. In each case, as many derivatives are formed for the KKF as prescribed by the order of the differential equation. The AKF require as many derivatives as there are of the exciting force in the differential equation. The correlation matrix is then formed from these values, only the various derivatives relating to a sampling instant being in one row. The correlation vector is formed from the KKF. The system of equations is solved as described. A separation of the known, slowly variable coefficients of the differential equation and quickly variable ones can be carried out as described, in order to determine the rate of rotation for a running gyro.

By observing the error vector with variation in the number of the derivatives used, it is, moreover, possible to determine the order of the differential equation on which a system is based.

It is to be seen that, in a coupled system of differential equations consisting of two equations, as occur in the case of MEMS, it is possible to make separate estimates of all the coefficients, which occur in different orders. The following can therefore be estimated separately: cross coupling of the input forces, cross coupling of the readout, attenuations, frequencies and the sum consisting of the rate of rotation and cross attenuation (from the cross coupling of the two pick-off signals). The cross couplings can be estimated separately only when the system does not degenerate into two identical differential equations (this being insignificant, however, for bias and scale factor).

The methods via the z-transformation or via the differential equation can both be effectively used, the latter yielding the parameters in an immediately understandable form. Both methods process the same input information in a similar way. The last method will require a somewhat longer computing time. However, there is no need to determine the parameters from the coefficients of the z-transformation, and so only the root function for determining the vibration frequency need be available in a DSP. This can also be dispensed with when the coefficient of a zeroth order is used directly for the electronic control of the second frequency.

“Third” vibrations (i.e. vibrations which differ from excitation vibration and readout vibration) can, of course, also be estimated—if desired—in both methods with the addition of further differential equations or z-transformations. Their coefficients converge with time, possibly slowly. Moreover, there is the problem of a separation of the coefficients that occur in the same derivatives. The problem can be overcome by the following: firstly, the parameters on the dominant mode are estimated. These coefficients are then assumed to be fixed, a system supplemented with the next strongest vibration is set up, and coefficients thereof are determined with the aid of the described separation into known and unknown coefficients. This method is repeated until the coefficients for the number of third vibrations which is of interest are determined. The influence of these vibrations can be calculated therefrom, and an appropriate bias correction carried out.

The use of a maximum likelihood method for estimating the parameters seems, moreover, not to offer any advantages. In accordance with a study of the literature relating to various alternatives, the method for the correlation that has been described currently obtains the best results and functions reliably in an absolute fashion. For the rest, it should be possible to control an MEMS gyro “normal” and simultaneously to supply noise to the pick-offs. The correlations can then be used to determine the error terms and correct bias and scale factor correspondingly.

The discretized, coupled system of differential equations that describes the system of force transmitters, resonator and excitation/readout vibration pick-offs preferably consists of two equations: in one, the excitation vibration signal is represented as a function of the force signal producing the excitation vibration and of the excitation vibration signal itself. It is also possible to take account of functions of the force signal that resets the readout vibration, functions of the readout vibration signal, and other functions. By analogy, in the second differential equation, the readout vibration signal is expressed as a function of the readout vibration signal and corresponding force signals that reset the readout vibration. It is also possible to take account of functions of the force signal that effects the excitation vibration, the excitation vibration signal and other functions. The functional relationships of the readout signals are defined by appropriate coefficients. Such coefficients define a linear transformation that maps the force signals onto the readout signals. If possible to calculate the coefficients, one may make statements relating to the magnitude of undesirable bias influences, rendering it possible to compensate such influences computationally and to produce a “clean” rate of rotation signal.

A plurality of methods can determine the coefficients. In a first embodiment, a white noise signal is supplied to the force transmitters for the excitation/change of excitation/readout vibration. Pick-off signals are determined that are proportional to the excitation/readout vibration. The noise and the pick-off signals are simultaneously sampled at periodic intervals. At least a portion of calculable autocorrelation values and cross-correlation values is determined from resulting sampled noise/pick-off values. The sampled pick-off values at a specific instant are expressed as a linear function, weighted by weighting factors, of calculated autocorrelation cross-correlation values of earlier instants. By combining a plurality of functions determined in such a manner, linear systems of equations are then formed whose coefficient matrices contain at least a portion of determined autocorrelation cross-correlation values whose coefficient vectors include cross-correlation values of the coefficient matrix, and whose variables to be determined are the weighting factors. Solving the systems of equations can determine the weighting factors that include information that has to be determined that characterizes the Coriolis gyro.

In a further embodiment, the coefficients are determined as follows: a white noise signal is supplied to the force transmitters for excitation/change of excitation/readout vibration. Pick-off signals are determined proportional to the excitation/readout vibration. Their noise and pick-off signals are sampled simultaneously at periodic time intervals. At least a portion of calculable autocorrelation and cross-correlation values are determined from resulting sampled noise/pick-off values. The time derivatives of the autocorrelation and cross-correlation values are then determined with the number of derivatives of the autocorrelation values corresponding to the number of possible derivatives of the noise signal values and the number of derivatives of the cross-correlation values corresponding to the order of the differential equations of the coupled system of differential equations. A plurality of linear systems of equations are formed whose coefficient matrices include at least a portion of determined autocorrelation cross-correlation values. Each row of the coefficient matrices is formed from the derivatives at a sampling instant whose coefficient vectors respectively include the cross-correlation values of the coefficient matrix and whose variables to be determined are the coefficients that describe the linear transformation. The linear transformation that includes the information characterizing the Coriolis gyro can therefore be determined by solving the system of equations.

The systems of equations for determining the coefficients describing the linear transformation are thus based on temporally different autocorrelation values/cross-correlation values. It is possible to obtain a good average of such values over time by repeated solution with the aid of temporally different correlation values.

Once the coefficients have been determined, it is possible, by substituting them in the coupled system of differential equations and taking account of instantaneous force signals of the force transmitters and instantaneous readout signals of the excitation/readout vibration pick-offs, to infer the instantaneous rate of rotation by solving the coupled system of differential equations with such values.

While the invention has been described with reference to its presently preferred embodiment, it is not limited thereto. Rather, the invention is limited only insofar as it is defined by the following set of patent claims and includes within its scope all equivalents thereof.

1. A simulation method for the operating behavior of a Coriolis gyro, in the case of which
the interaction of the system comprising force transmitters, a mechanical resonator and excitation/readout vibration pick-offs is represented as a discretized, coupled system of differential equations,
the variables of the system of equations representing the force signals supplied by the force transmitters to the mechanical resonator and the readout signals produced by the excitation/readout vibration pick-offs, and the coefficients of the system of equations containing information relating to the linear transformation which maps the force signals onto the readout signals,
the coefficients are determined by measuring force signal values and readout signal values at different instants and substituting them into the system of equations, and the system of equations is numerically resolved in accordance with the coefficients, and
the coefficients are used to infer undesired bias properties of the Coriolis gyro which corrupt the rate of rotation of the Coriolis gyro.

2. The method as claimed in claim 1, characterized in that the determination of the coefficients results from the fact that
in each case a white noise signal is supplied to the force transmitters for the excitation/change of excitation/readout vibration, and pick-off signals proportional to the excitation/readout vibration are determined,
the noise signals and the pick-off signals being sampled simultaneously at periodic time intervals,
at least a portion of calculable autocorrelation values and cross-correlation values is determined from resulting sampled noise/pick-off values,
the sampled pick-off values of a specific instant are respectively expressed as a linear function, weighted by weighting factors, of calculated autocorrelation values/cross-correlation values of earlier instants, and
by combining a plurality of functions determined in such a way, linear systems of equations are formed whose coefficient matrices respectively contain at least a portion of determined autocorrelation values/cross-correlation values, whose coefficient vectors respectively include the cross-correlation values of the coefficient matrix, and whose variables to be determined are the weighting factors,
solving the systems of equations determining the weighting factors that are the coefficients to be determined and in which the information that is to be determined and characterizes the Coriolis gyro is included.

3. The method as claimed in claim 1, characterized in that the determination of the coefficients results from the fact that
in each case a white noise signal is supplied to the force transmitters for the excitation/change of excitation/readout vibration, and pick-off signals proportional to the excitation/readout vibration are determined,
the noise signals and the pick-off signals being sampled simultaneously at periodic time intervals,
at least a portion of calculable autocorrelation values and cross-correlation values is determined from resulting sampled noise/pick-off values,
the time derivatives of the autocorrelation values and cross-correlation values are determined, the number of derivatives of the autocorrelation values corresponding to the number of possible derivatives of the noise signal values, and the number of derivatives of the cross-correlation values corresponding to the order of the differential equations, and
linear systems of equations are formed whose coefficient matrices respectively include at least a portion of determined autocorrelation values/cross-correlation values, each row of the coefficient matrices respectively being formed from the derivatives at a sampling instant whose coefficient vectors respectively include the cross-correlation values of the coefficient matrix, and whose variables to be determined are the coefficients that describe the linear transformation,
the linear transformation in which the information characterizing the Coriolis gyro is included being determined by solving the systems of equations.

4. The method as claimed in claim 1, characterized in that the instantaneous rate of rotation is inferred on the basis of the determined coefficients, describing the linear transformation, of instantaneous force signals of the force transmitters and instantaneous readout signals of the excitation/readout vibration pick-offs.

5. Operating method for a Coriolis gyro, in the case of which
the interaction of the system comprising force transmitters, a mechanical resonator and excitation/readout vibration pick-offs is represented as a discretized, coupled system of differential equations,
the variables of the system of equations representing the force signals supplied by the force transmitters to the mechanical resonator and the readout signals produced by the excitation/readout vibration pick-offs, and the coefficients of the system of equations containing information relating to the linear transformation which maps the force signals onto the readout signals,
the coefficients are determined by measuring force signal values and readout signal values at different instants and substituting them in the system of equations, and the system of equations is numerically resolved in accordance with the coefficients, and
an instantaneous rate of rotation is inferred on the basis of the determined coefficients, describing the linear transformation, of instantaneous force signals of the force transmitters and instantaneous readout signals of the excitation/readout vibration pick-offs.

6. The method as claimed in claim 5, characterized in that the determination of the coefficients results from the fact that
in each case a white noise signal is supplied to the force transmitters for the excitation/change of excitation/readout vibration, and pick-off signals proportional to the excitation/readout vibration are determined,
the noise signals and the pick-off signals being sampled simultaneously at periodic time intervals,
at least a portion of calculable autocorrelation values and cross-correlation values is determined from resulting sampled noise/pick-off values,
the sampled pick-off values of a specific instant are respectively expressed as a linear function, weighted by weighting factors, of calculated autocorrelation values/cross-correlation values of earlier instants, and
by combining a plurality of functions determined in such a way, linear systems of equations are formed whose coefficient matrices respectively contain at least a portion of determined autocorrelation values/cross-correlation values, whose coefficient vectors respectively include the cross-correlation values of the coefficient matrix, and whose variables to be determined are the weighting factors,
solving the systems of equations determining the weighting factors that are the coefficients to be determined and in which the information that is to be determined and characterizes the Coriolis gyro is included.

7. The method as claimed in claim 5, characterized in that the determination of the coefficients results from the fact that
in each case a white noise signal is supplied to the excitation/change of excitation/readout vibration, and pick-off signals proportional to the excitation/readout vibration are determined,
the noise signals are the pick-off signals being sampled simultaneously at periodic time intervals,
at least a portion of calculable autocorrelation values and cross-correlation values is determined from resulting sampled noise/pick-off values,
the time derivatives of the autocorrelation values and cross-correlation values are determined, the number of derivatives of the autocorrelation values corresponding to the number of possible derivatives of the noise signal values, and the number of derivatives of the cross-correlation values corresponding to the order of the differential equations, and
linear systems of equations are formed whose coefficient matrices respectively include at least a portion of determined autocorrelation values/cross-correlation values, each row of the coefficient matrices respectively being formed from the derivatives at a sampling instant whose coefficient vectors respectively include the cross-correlation values of the coefficient matrix, and whose variables to be determined are the coefficients that describe the linear transformation.
